(19) United States
(12) Patent Application Publication
(10) Pub. No.: US 2013/0105062 A1
(43) Pub. Date: May 2, 2013

(54) APPARATUS FOR LAMINATING A PHOTOVOLTAIC LAYUP, AND A METHOD OF LAMINATING THE SAME

(71) Applicants: Noel Rivas CENA, Singapore (SG); Lian Hok TAN, Singapore (SG)

(72) Inventors: Noel Rivas CENA, Singapore (SG); Lian Hok TAN, Singapore (SG)

(73) Assignee: ASM TECHNOLOGY SINGAPORE PTE. LTD., Singapore (SG)

(21) Appl. No.: 13/287,273

(22) Filed: Nov. 2, 2011

(51) Int. Cl. B32B 37/02; B32B 41/00; B32B 37/14; B32B 37/00

(52) U.S. Cl. 156/64; 156/538; 156/378; 156/60

(57) ABSTRACT

Disclosed is an apparatus for laminating a photovoltaic layup, which comprises a plurality of layers, one of the plurality of layers including a plurality of interconnected solar cells. The apparatus comprises: i) a conveying device operative to convey the photovoltaic layup into the apparatus; ii) a heating device operative to heat the photovoltaic layup; and iii) a pressing device operative to press the photovoltaic layup. In particular, the pressing device is configured to press the photovoltaic layup towards the heating device, whilst the photovoltaic layup is being conveyed by the conveying device across the apparatus. A method of laminating the photovoltaic layup is also disclosed.

### FIELD OF THE INVENTION

This invention relates to an apparatus for laminating a photovoltaic layup which comprises a plurality of interconnected solar cells. The invention also relates to a method of laminating the photovoltaic layup.

### BACKGROUND OF THE INVENTION

A photovoltaic layup typically comprises five layers of material, namely i) a plurality of interconnected solar cells; ii) two layers of encapsulant (e.g. Ethylene Vinyl Acetate, EVA); iii) a glass sheet; and iv) a back sheet. In particular, the plurality of interconnected solar cells are arranged between the layers of encapsulant, whereas the layers of encapsulant are arranged between the glass sheet and the back sheet.

Lamination of the photovoltaic layup is necessary to protect it from the external environment, so that the laminated photovoltaic layup will have a useful life of at least 25 years. Conventionally, a laminating system requires two separate stations: i) a laminating station and ii) a cooling system. The photovoltaic layup is first conveyed to a laminating station, which comprises i) a heating platen for heating the photovoltaic layup and ii) a membrane for pressing the photovoltaic layup towards the heating platen.

Specifically, the heating platen is initially heated to about 150° C. before the photovoltaic layup is introduced into the laminating station. Whilst the photovoltaic layup remains stationary in the laminating station, a vacuum pump generates vacuum of up to 1 millibar in the air-tight laminating station. The vacuum evacuates air from the layers of the photovoltaic layup and the encapsulant liquefies. About four minutes later, the vacuum pump is deactivated and the membrane is lowered from the top of the laminating station to press the photovoltaic layup close to the heated platen. At this time, the photovoltaic layup still remains stationary in the laminating station. The combination of pressure and heat accordingly hardens the encapsulant and converts the layers of the photovoltaic layup into laminates. After curing of the photovoltaic layup is completed, the membrane is then raised to its original position at the top of the laminating station and the photovoltaic layup is conveyed from the laminating system to a cooling station. The cooling station comprises a cooling platen for cooling the heated photovoltaic layup. Specifically, the cooling platen is cooled by chilled water, which in turn cools the photovoltaic layup to a temperature of about 25° C. before the photovoltaic layup is finally off-loaded from the laminating system.

There are various limitations with conventional laminating systems. For instance, conventional laminating systems typically require high temperature uniformity within about a 2° C. range for the lamination process. Such a high temperature uniformity may be technically difficult to achieve. Thus, it is an object of this invention to seek to propose an apparatus for laminating a photovoltaic layup that at least ameliorates the problem described above.

### SUMMARY OF THE INVENTION

A first aspect of the present invention is an apparatus for laminating a photovoltaic layup which comprises a plurality of layers, one of the plurality of layers including a plurality of interconnected solar cells. Specifically, the apparatus comprises: i) a conveying device operative to convey the photovoltaic layup; ii) a heating device operative to heat the photovoltaic layup; and iii) a pressing device operative to press the photovoltaic layup. In particular, the pressing device is configured to press the photovoltaic layup towards the heating device, whilst the photovoltaic layup is being conveyed by the conveying device across the apparatus.

By configuring the pressing device to press the photovoltaic layup towards the heating device whilst the photovoltaic layup is being conveyed across the apparatus, surface temperature variation of the heating device will be compensated by the movement of the photovoltaic layup across the apparatus whilst the photovoltaic layup is being pressed by the pressing device towards the heating device. By contrast, a photovoltaic layup remains stationary in a conventional laminating system whilst a membrane is lowered from the top of the laminating system to press the stationary photovoltaic layup towards the heating platen. Thus, surface temperature variation of the heating device in the conventional laminating system may not be as readily compensated as is the case in the present invention. Thus, embodiments of the claimed apparatus may relax the constraint of surface temperature variation of the heating device as compared with conventional laminating systems. Advantageously, embodiments of the claimed apparatus may be more easily constructed than conventional laminating systems.

Some preferred features have been defined in the dependent claims.

For instance, the pressing device may be configured to move synchronously with the conveying device while pressing the photovoltaic layup towards the heating plate. Advantageously, the synchronized motion of the pressing device and the conveying device may prevent relative displacement between the layers of the photovoltaic layup, thereby ensuring its final quality.

Further, the apparatus may comprise an interconnecting device for connecting the conveying device to the pressing device. The conveying device may be operative to be driven by a motor, which also drives the pressing device through the interconnecting device. Advantageously, the interconnecting device may ensure that the pressing device is configured to move synchronously with the conveying device, while pressing the photovoltaic layup towards the heating device as the photovoltaic layup is being conveyed across the apparatus.

In addition, the apparatus may comprise a vacuum generating device operative to generate vacuum suction for evacuating air from the photovoltaic layup. By providing the vacuum generating device that is housed separately from the heating and pressing devices, the vacuum generating device may operate independently of the heating and pressing devices. In contrast to conventional laminating systems, the vacuum pump together with the heating platen and the membrane are all housed within the laminating station. Thus, the steps of evacuating air from a photovoltaic layup and curing of the photovoltaic layup are performed sequentially within the laminating station. Since the steps of evacuating air and curing may be performed in parallel on different photovoltaic layups in embodiments of the present invention, the required operational time is reduced and the overall throughput will be higher than that of conventional laminating systems. Furthermore, the separation of the vacuum generating device from the heating and pressing devices means that a smaller machine footprint may be required for evacuating air from the photovoltaic layup than the footprint of the laminating station of conventional laminating systems. Advantageously, the power requirement of the vacuum generating device may be less than that as required by the vacuum pumps of conventional laminating systems.

Moreover, the apparatus may further comprise an inspection device that is operative to detect the presence of air voids in the photovoltaic layup. Advantageously, this provides a feedback loop for adjusting the operating specifications of embodiments of the claimed apparatus for optimal performance.

A second aspect of the invention is a method of laminating a photovoltaic layup which comprises a plurality of layers, one of the plurality of layers including a plurality of interconnected solar cells. Specifically, the method comprises the steps of: conveying the photovoltaic layup with a conveying device to a laminator, the laminator comprising a heating device; heating the photovoltaic layup with the heating device after the photovoltaic layup has been conveyed to the laminator; and pressing the photovoltaic layup towards the heating device with a pressing device while the photovoltaic layup is being conveyed across the laminator.

Some preferred features of the method have also been defined in the dependent claims.

### BRIEF DESCRIPTION OF THE DRAWINGS

Preferred embodiments of the invention will now be described, by way of example only, with reference to the accompanying drawings of which:

FIG. 1 a is a perspective view of the laminator, which comprises a curing station and a cooling station;

FIG. 1b is a side view of the laminator of FIG. 1a;

FIG. 2 is a perspective view of the curing station and the cooling station of the laminator of FIG. 1a;

FIG. 3a and FIG. 3b are different side views of the curing and cooling stations of FIG. 2;

FIG. 4a and FIG. 4b show a frame structure of the curing station of FIG. 2 in raised and lowered positions respectively;

FIG. 5 shows a pressing device of the curing station of FIG. 2;

FIG. 6 shows a membrane tensioning device of the pressing device of FIG. 5; and

FIG. 7a shows timing belt tensioning devices of the pressing device of FIG. 5, while FIG. 7b is a perspective view of one of the timing belt tensioning devices of FIG. 7a.

### DETAILED DESCRIPTION OF THE PREFERRED EMBODIMENTS

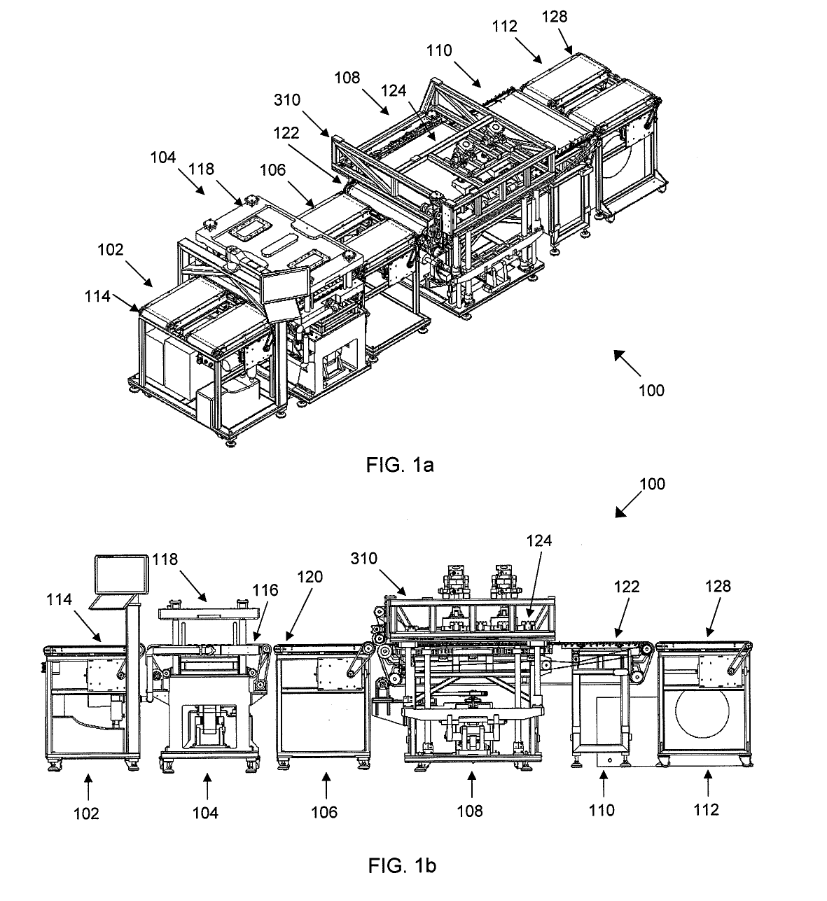

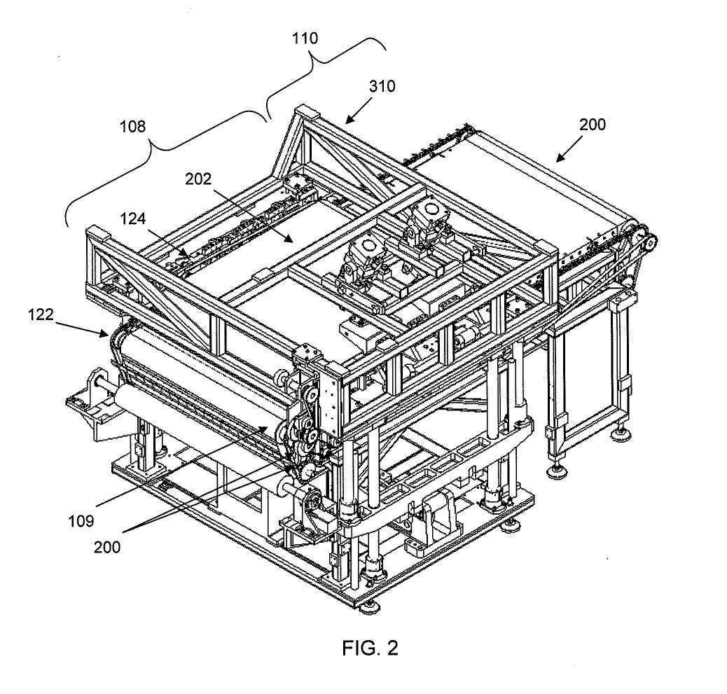

FIG. 1a and FIG. 1b respectively show a perspective view and a side view of a laminator 100 for laminating a work piece such as a photovoltaic layup. The photovoltaic layup comprises a plurality of layers including an encapsulant, a plurality of interconnected solar cells (e.g. two interconnected monocrystalline-silicon solar cells), and glass. The laminator 100 comprises six separate stations, namely: i) a first onloading station 102; ii) a vacuum station 104; iii) a second onloading station 106; iv) a curing station 108; v) a cooling station 110; and vi) an offloading station 112.

The first onloading station 102 comprises a conveyor 114, which has a conveyor belt operative to receive the work piece and to convey the received work piece into the vacuum station 104 of the laminator 100.

The vacuum station 104 comprises another conveyor 116, a heating platen, a top cover 118, and a vacuum pump. Specifically, the conveyor 116 has a conveyor belt operative to receive the work piece from the first onloading station 102 and to convey the received work piece to the second onloading station 106. In particular, the conveyor belt of the conveyor 116 comprises a fabric made of polytetrafluoroethylene (PTFE). Before the vacuum station 104 receives the work piece from the first onloading station 102, the heating platen is first heated to a temperature of about 60-100° C. After the photovoltaic layup is properly arranged within the vacuum station 104, the top cover 118 closes to create an air-tight chamber after which the vacuum pump generates vacuum of up to 1 millibar within a minute—the vacuum is maintained for about four minutes to allow trapped air to escape from within the layers of the stationary work piece. The encapsulant then liquefies and the interconnected solar cells are sealed by the liquefied encapsulant. Subsequently, the vacuum pump is deactivated and the top cover 118 opens before the work piece is conveyed from the vacuum station 104 to the second onloading station 106. As the work piece is being conveyed from the vacuum station 104 to the second onloading station 106, a new work piece may be simultaneously introduced into the vacuum station 104 to undergo the same process as described above.

The second onloading station 106 comprises another conveyor 120 for conveying the work piece to the curing station 108, and a sensor for object detection. Once the second onloading station 106 receives the work piece from the vacuum station 104 at one end of the conveyor 120, the conveyor 120 is configured to accelerate from its usual idling speed to convey the work piece to the curing station 108. The conveyor 120 continues to move at the higher speed until the work piece is detected by the sensor arranged at the opposite end of the conveyor 120. As soon as the work piece is detected by the sensor, the conveyor 120 immediately reduces its speed to synchronize with the speed of a separate conveyor 122 in the curing station 108. This ensures that the work piece transits smoothly from the second onloading station 106 to the curing station 108, instead of an abrupt change in speed that may result in an undesirable displacement of the layers within the work piece.

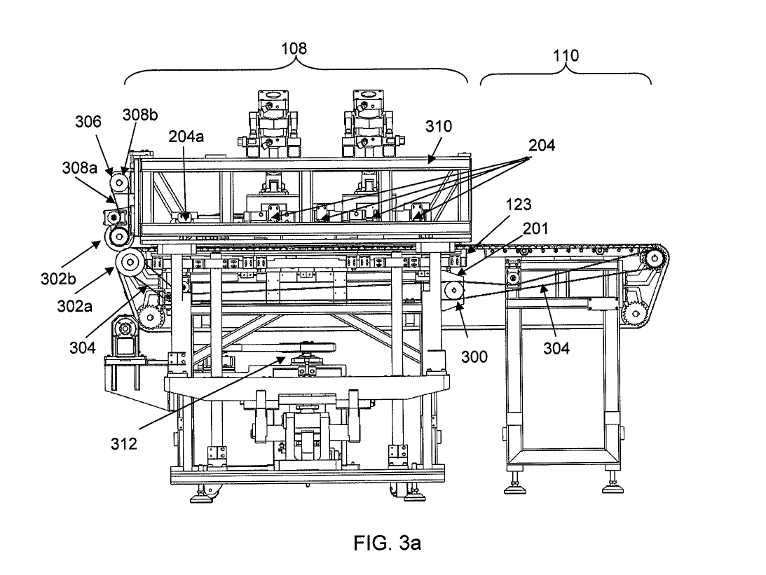

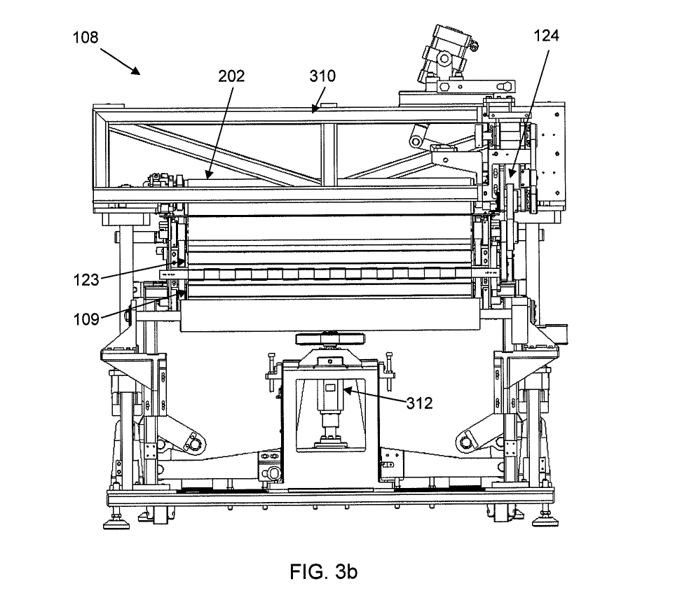

In addition to the conveyor 122 for conveying the work piece along a conveying path from the curing station 108 to the cooling station 110, the curing station 108 also comprises a heating device (e.g. a heating platen 123 shown in FIG. 3a, which may measure about 1.2 m in length and about 0.9 in width) and a pressing device 124. The conveyor 122 of the curing station 108 comprises a conveyor belt that includes a PTFE fabric 109 (shown in FIG. 2) for supporting and conveying the work piece. Like the conveyor 122, the pressing device 124 also comprises a conveyor belt. Also, the heating platen 123 is in contact with the conveyor 122 for transmitting heat to the work piece through the conveyor 122.

Further, the curing station 108 comprises a frame structure 310 to which the pressing device 124 is attached. Specifically, the frame structure 310 is actuated by a hydraulic device 312 to be lowered towards, or raised from, the conveyor 122. Before the curing station 108 receives the work piece for curing, the frame structure 310 is actuated by the hydraulic device 312 to lower the pressing device 124 until a gap of about 4-5 mm between the pressing unit 124 and the conveyor 122 is created. In addition, the heating platen 123 is heated to a temperature of about 150° C.

Before the work piece enters the curing station 108 through the gap between the pressing device 124 and the conveyor 122, the conveyor 122 and the conveying belt of the pressing device 124 are configured to rotate in reverse directions. Thus, the work piece will be pressed by the pressing device 124 towards and close to the heating platen 123 as the work piece enters the curing station 108 and is being conveyed across the curing station 108. In particular, the conveyor 122 and the conveying belt of the pressing device 124 move at a speed to convey the work piece, such that the work piece is fully cured by the time it leaves the curing station 108. Accordingly, the curing of the work piece and the conveying of the work piece across the curing station 108 can take place simultaneously.

Although in the described embodiment, the work piece does not directly contact the heating platen 123 when pressed by the pressing device 124 close to heating platen 123 due to the intervening PTFE fabric 109 of the conveyor 122, it should be appreciated that in other embodiments, the work piece may directly contact the heating platen 123 when pressed by the pressing device 123 towards and close to the heating platen 123.

It should also be appreciated that the frame structure 310 may be actuated by the hydraulic device 124 to lower the pressing device 124 such that the gap between the pressing device 124 and the conveyor 122 corresponds to the thickness of the work piece.

Further, it should be appreciated that the photovoltaic layup is not limited by the number of interconnected solar cells. For instance, the photovoltaic layup may have as few as two interconnected solar cells or as many as 256 interconnected solar cells, depending on the desired size of the photovoltaic layup.

After curing, the work piece is conveyed to the cooling station 110 for cooling. The cooling station 110 comprises a cooling platen, which is cooled by chilled water, and the cooling platen in turn cools the work piece. Although the cooling station 110 is separated from the curing station 108, the same conveyor 122 is used to convey the work piece across the cooling station 110. With the cooling platen in close contact to the conveyor 122, the work piece can be cooled to about 25° C. The cooling process will last for about four minutes before the work piece is conveyed to the offloading station 112, which comprises yet another conveyor 128 for receiving a fully cured and cooled laminated work piece from the cooling station 110.

It should be appreciated that by configuring the vacuum station 104 and the curing station 108 as separate stations, the vacuum station 104 may operate independently of the curing station 108. By performing the steps of evacuating air from photovoltaic layups and curing of photovoltaic layups in parallel in the vacuum station 104 and the curing station 108 respectively, overall throughput of the laminator 100 may be improved, as compared with performing those steps sequentially. Furthermore, the separation of the vacuum station 104 from the curing station 108 means that a smaller machine footprint may be required for evacuating air from the photovoltaic layup than the footprint of the machine that combines the vacuum station 104 and the curing station 108 into a single station. This advantageously reduces the power requirement of the vacuum station 104 of the laminator 100.

FIG. 2 shows a perspective view of the curing and cooling stations 108, 110 of the laminator 100.

Specifically, the fabric 109 of the conveyor 122 that supports the work piece is mounted on a plurality of conveyor rollers 200, which are connected to a motor (shown in FIG. 3a as an AC servo motor 201). Thus, the plurality of rollers 200 of the conveyor 122 are driven by the AC servo motor 201 to move the conveyor fabric 109, which in turn conveys the work piece across the curing station 108. In particular, the conveyor 122 comprises an arrangement of conveyor chains, timing belts, and gears for conveying the work piece across the curing station 108.

The pressing device 124 in the curing station 108 comprises a membrane 202 attached to a plurality of pressing rollers 204 (shown in FIG. 3a). Thus, the membrane 202 moves when it is driven by one or more of the pressing rollers 204. Like the conveyor 122, the pressing device 124 also comprises an arrangement of timing belts and conveyor chains. In particular, the pressing device 124 is interconnected with the conveyor 122 via an interconnecting device, which comprises a gear and a timing belt (described below). Thus, the AC servo motor 201 is operative to drive the conveyor 122 which in turn drives the pressing device 124 via the interconnecting device.

FIG. 3a and FIG. 3b show side views of the curing and cooling stations 108, 110 along and traverse to the conveying path of the work piece respectively.

Referring to FIG. 3a, a motor gear 300 is driven by the AC servo motor 201 during the curing process. The motor gear 300 is further interconnected with a conveyor gear 302a via a timing belt 304, while the conveyor gear 302a is interconnected with a corresponding conveyor gear 302b. Thus, power from the AC servo motor 201 is transmitted through the timing belt 304 to the conveyor gears 302a, 302b. A reverse direction mechanism is also provided through the gear arrangement—i.e. when the conveyor gear 302a rotates in a clockwise direction to convey the work piece across the curing station 108, the corresponding conveyor gear 302b rotates in the opposite anti-clockwise direction.

Furthermore, the conveyor gear 302b is connected to a pressing roller 204a via an intermediate gear 306 and timing belts 308a, 308b. Thus, this pressing roller 204a drives the membrane 202 together with the other pressing rollers 204 when the AC servo motor 201 is activated.

FIG. 3b shows the configuration of the curing station 108 after the frame structure 310 has been actuated by the hydraulic device 312 to lower the pressing device 124 until a gap of about 4-5 mm between the pressing unit 124 and the conveyor 122 is created. Accordingly, the membrane 202 is configured to press the work piece towards the heating platen 123. Thus, curing of the work piece begins immediately as soon as it enters the curing station 108 and curing continues as the work piece is being conveyed across the curing station 108.

Preferably, the membrane 202 of the pressing device 124 is made of rubberized silicon (i.e. silicon rubber).

By configuring the pressing device 124 to press the photovoltaic layup towards the heating platen 123 while the photovoltaic layup is being conveyed across curing station 108, surface temperature variation of the heating platen 123 may be compensated by the movement of the photovoltaic layup across the curing station 108 whilst the photovoltaic layup is being pressed by the pressing device 124 close to the heating platen 123. Advantageously, the curing station 108 relaxes the constraint of having to maintain surface temperature uniformity of the heating platen 123 within a small range.

It should be appreciated that the arrangement of the conveyor gears 302a, 302b and the timing belts 302a, 302b, 304, 308a, 308b may advantageously ensure that the pressing device 124 is configured to move synchronously with the conveying device whilst pressing the photovoltaic layup towards the heating device 123.

The synchronized motion of the pressing device and the conveying device may prevent any relative displacement of the layers of the photovoltaic device, and advantageously ensure the final quality of the laminated photovoltaic layup.

Additionally, the laminator 100 outputs individual laminated work pieces in a time-linear fashion—for instance, one laminated work piece is offloaded from the laminator 100 around every 4 minutes during production. By contrast, laminated work pieces are produced in batches by conventional laminating systems—for instance, four laminated work pieces are offloaded from a conventional laminating system every 15 minutes. The present inventors have discovered that it is easier to manage the laminated work pieces that are individually offloaded from the laminator 100, as compared with managing laminated work pieces that are offloaded in batches by conventional laminating systems.

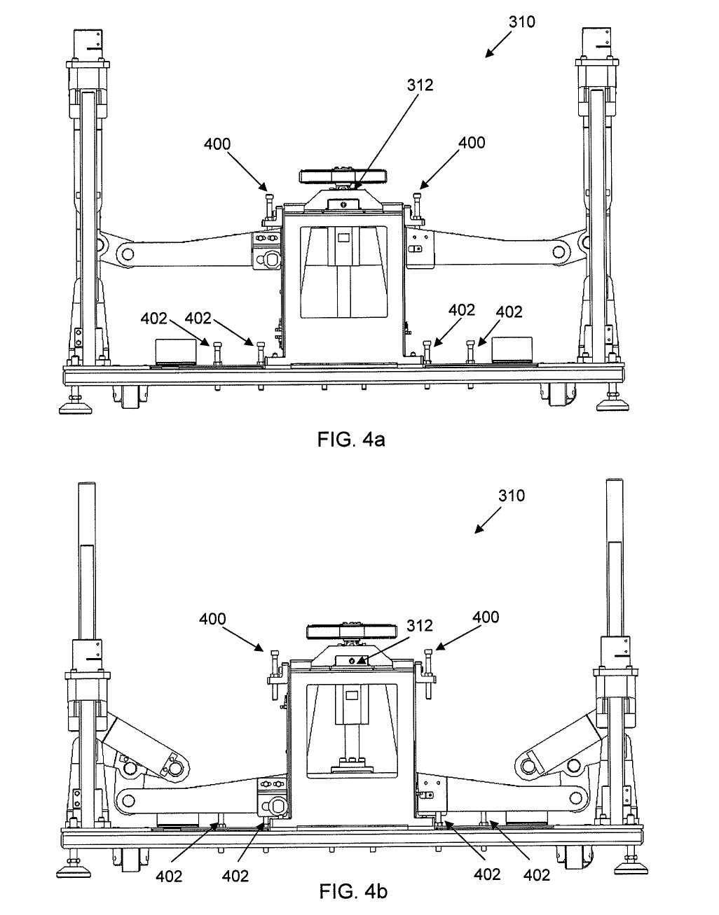

FIG. 4a and FIG. 4b show the frame structure 310 of the curing station 108 in its raised and lowered positions respectively.

It can be seen in FIG. 4a and FIG. 4b that the frame structure 310 includes top limiting screws 400 and bottom limiting screws 402, which prevent the pressing device 124 from being raised above a certain height and from being lowered below a certain height. Accordingly, these top and bottom limiting screws 400, 402 ensure that the pressing device 124 is actuated by the hydraulic device 312 within a defined range of motion. Preferably, the top and bottom limiting screws 400, 402 maintain the precise relative arrangement of the gears and timing belts between the pressing device 124 and the conveyor 122. Otherwise, any disturbance to the precise relative arrangement of the gears and timing belts as caused by an overshoot of the frame structure 310 above its raised position, or an undershoot of the frame structure 310 below its lowered position, may result in non-synchronization in the motion of the pressing device 124 and the conveyor 122.

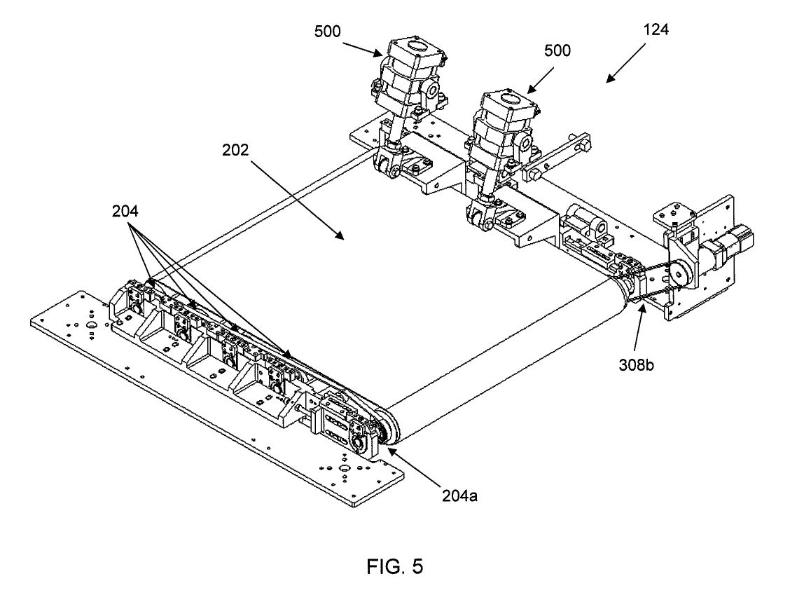

FIG. 5 shows a perspective view of the pressing device 124 in the curing station 108 comprising two actuators 500. Specifically, the two actuators 500 are operative to lift along one side of the pressing device 124. Thus, these actuators 500 advantageously facilitate replacement of the membrane 202 of the pressing device 124 that may have been worn out due to repeated use.

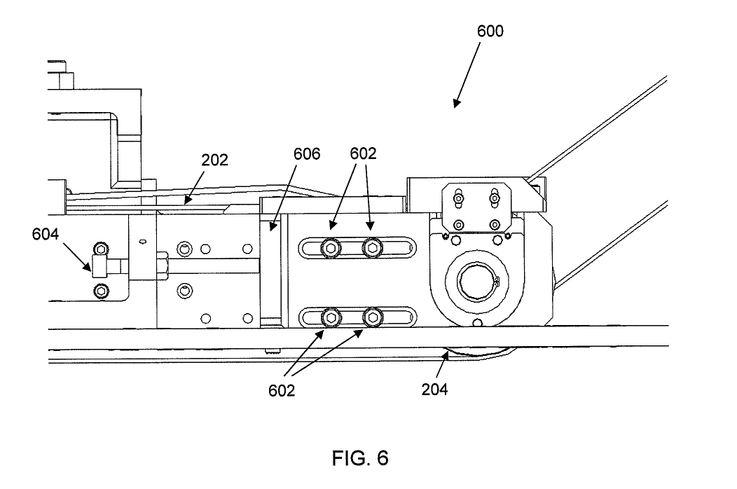

Further, FIG. 6 shows a membrane tensioning device 600 of the pressing device 124 for tensioning its membrane 202. The membrane tensioning device 600 comprises fixed screws 602 that connect with one of the pressing rollers 204, an adjusting screw 604, and a plate 606 arranged between the fixed screws 602 and the adjusting screw 604. By tightening the adjusting screw 604, the adjusting screw 604 causes the plate 604 to create a tension force on the membrane 202. Preferably, the membrane tensioning device 600 is capable of extending the membrane 202 by about 4% of its original length.

Accordingly, the membrane 202 of the pressing device 124 can be made taut through the use of the membrane tensioning device 600. Thus, the membrane 202 is completely flat as it presses the photovoltaic layup towards the heating platen 123 whilst the photovoltaic layup is being conveyed across the curing station 108. Advantageously, the membrane tensioning device 600 ensures that a uniform pressure is exerted on the photovoltaic layup to maximize quality of the curing process.

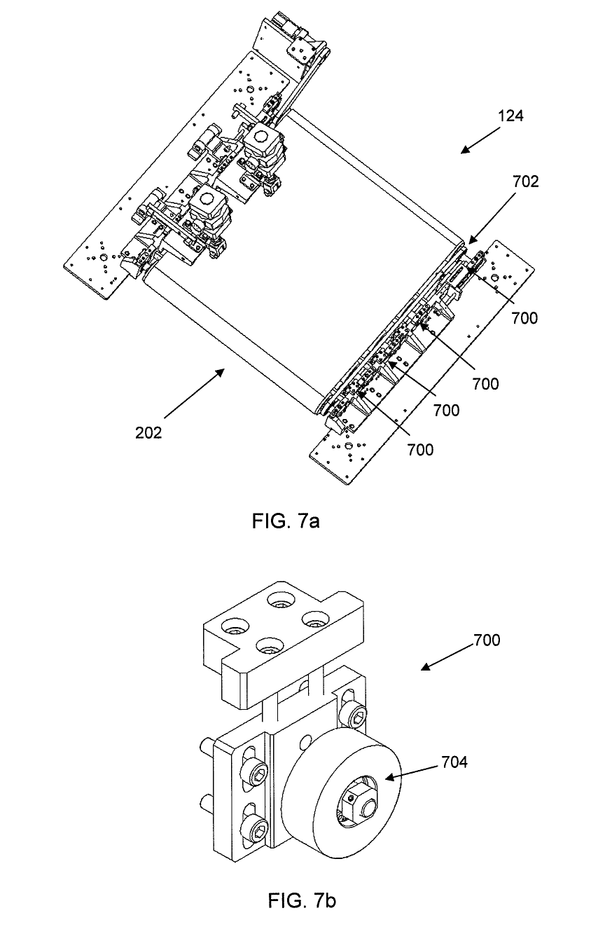

Moreover, FIG. 7a shows a timing belt 702 arranged with respect to the pressing rollers 204, 204a and a plurality of timing belt tensioning devices 700 of the pressing device 124. Specifically, each of the timing belt tensioning devices 700 is arranged between the pressing rollers 204, 204a for tensioning the timing belt 702 against the adjacent pressing rollers 204, 204a. Thus, when the pressing roller 204a is driven by the AC servo motor 201, it accordingly drives the other pressing rollers 204 to rotate the membrane 202 of the pressing device 124 in an endless loop.

FIG. 7b is a detailed view of one of the timing belt tensioning devices 700, which comprises a round knob 704 that engages with the timing belt 702 to tension the timing belt 702 against the pressing rollers 204, 204a.

It should be appreciated that other embodiments of the present invention are possible without departing from the scope of the invention. For instance, the laminator 100 may further comprise a level adjustment device for adjusting or fine-tuning the level (i.e. height) of the frame structure 310 to which the pressing device 124 is attached. Such a level adjustment device may, for instance, include adjustable screws that are configured to adjust the position of the frame structure 310 (and therefore, the pressing device 124) with respect to the conveyor 122. In addition, each of the conveyor 122, the pressing unit 124, and/or the frame structure 310 may be removable from the laminator 100 for maintenance and cleaning.

Furthermore, the laminator 100 may be provided with an inspection device for detecting presence of air voids in the photovoltaic layup. The inspection device may comprise an alarm which activates to alert an operator upon detecting the presence of air voids in the photovoltaic layup. The inspection device may be positioned either at the curing station 108 (e.g. at the input of the conveyor 122), or at the cooling station 110. Such an inspection device may advantageously provide a feedback system to adjust the operating specifications of the laminator 100, thereby optimizing performance of the laminator 100.

1. An apparatus for laminating a photovoltaic layup, the photovoltaic layup comprising a plurality of layers, one of the plurality of layers including a plurality of interconnected solar cells, the apparatus comprising:
a conveying device operative to convey the photovoltaic layup;
a heating device operative to heat the photovoltaic layup; and
a pressing device operative to press the photovoltaic layup,
wherein the pressing device is configured to press the photovoltaic layup towards the heating device while the photovoltaic layup is being conveyed by the conveying device across the apparatus.

2. The apparatus of claim 1, wherein the pressing device is configured to move synchronously with the conveying device while pressing the photovoltaic layup towards the heating device.

3. The apparatus of claim 1, further comprising an interconnecting device configured to connect the conveying device to the pressing device.

4. The apparatus of claim 3, wherein the conveying device is operative to be driven by a motor to thereby drive the pressing device through the interconnecting device.

5. The apparatus of claim 3, wherein the interconnecting device comprises a gear and a belt.

6. The apparatus of claim 1, wherein the pressing device comprises a conveyor belt configured to press the photovoltaic layup towards the heating device.

7. The apparatus of claim 6, wherein the conveyor belt comprises a membrane made of silicon rubber.

8. The apparatus of claim 7, wherein the conveyor belt further comprises a membrane tensioning device configured to tension the membrane.

9. The apparatus of claim 1, further comprising a vacuum generating device operative to generate vacuum to evacuate air from the photovoltaic layup.

10. The apparatus of claim 9, wherein the vacuum generating device is housed separately from the heating and pressing devices.

11. The apparatus of claim 10, further comprising a conveyor configured to convey the photovoltaic layup from the vacuum generating device to the conveying device.

12. The apparatus of claim 11, further comprising a sensor configured to detect the photovoltaic layup.

13. The apparatus of claim 12, wherein the conveyor is operative to reduce its speed to a speed of the conveying device upon the sensor detecting the photovoltaic layup.

14. The apparatus of claim 1, further comprising a cooling device operative to cool the photovoltaic layup.

15. The apparatus of claim 14, wherein the cooling device is separated from the heating and pressing devices.

16. The apparatus of claim 1, further comprising an inspection device operative to detect presence of air voids in the photovoltaic layup.

17. The apparatus of claim 16, wherein the inspection device further comprises an alarm operative to activate upon detecting the presence of air voids in the photovoltaic layup.

18. A method of laminating a photovoltaic layup, the photovoltaic layup comprising a plurality of layers, one of the plurality of layers including a plurality of interconnected solar cells, the method comprising the steps of:
conveying the photovoltaic layup with a conveying device to a laminator, the laminator comprising a heating device;
heating the photovoltaic layup with the heating device after the photovoltaic layup has been conveyed to the laminator; and
pressing the photovoltaic layup towards the heating device with a pressing device while the photovoltaic layup is being conveyed across the laminator.

19. The method of claim 18, further comprising the step of detecting presence of air voids in the photovoltaic layup.

20. The method of claim 19, wherein the step of detecting the presence of air voids comprises activating an alarm upon the detection of air voids in the photovoltaic layup.
